(19) United States
(12) Patent Application Publication
(10) Pub. No.: US 2026/0063153 A1
(43) Pub. Date: Mar. 5, 2026

(54) HOLD DOWN MECHANISMS WITH DELAYED RELEASE

(71) Applicant: HONEYBEE ROBOTICS, LLC, Longmont, CO (US)

(72) Inventors: Kris Zacny, Altadena, CA (US); Gale Paulsen, Arcadia, CA (US)

(21) Appl. No.: 18/823,080

(22) Filed: Sep. 3, 2024

(51) Int. Cl. F15B 15/26

(52) U.S. Cl. CPC F15B 15/26; F15B 2015/268; F15B 2215/30

(57) ABSTRACT

Systems and methods disclosed herein are directed reusable hold down mechanisms. A locking material, such as a low melting point metal, can be used to hold an actuating rod in place while the locking material is below the melting point. A heater can be used to increase the temperature of the locking material to at least the melting point, causing the locking material to no longer hold the actuating rod in place. A biasing element, such as a spring, can then cause the released pin to move in a specific direction, which can then contact a physical element or component to actuate a physical device. The actuating rod can be reset while the locking material is in a liquid, viscous, or similar state, allowing the hold down mechanism to be reused without removal or the need for specialized tooling.

### TECHNICAL FIELD

Developments disclosed and suggested herein relate generally to mechanisms that can be used to hold and release one or more components on command, and in particular to reusable hold-down and release mechanisms (HDRMs) that can be used under a variety of environmental conditions.

### BACKGROUND

For many mechanical systems, there is a need to actuate various mechanical mechanisms or physical elements at specific times, or corresponding to certain events. Oftentimes this involves a mechanical action performed with sufficient force or pressure to perform the necessary actuation. Prior approaches have used hold down and release mechanisms to perform actuation with respect to mechanical elements, such as to press a button or rotate a lever. In many instances, these HDRMs are used once and then discarded. For example, an explosive HDRM may provide for fast release upon a triggered explosive event, but that HDRM is then unable to be reused. In addition to such HDRMs being expensive to purchase, install, and remove, the need to test components under various environmental conditions means that multiple HDRMs are needed in many testing situations.

### SUMMARY

Disclosed herein are hold down mechanisms, and similar actuator devices, that are reusable and do not require special tooling to reset. These hold down mechanisms can include a “locking” material inside a housing that has at least two states. In a first state, such as a solid state, the locking material is able to hold an actuating element in place. In a second state, such as a liquid or viscous state, the locking material allows the actuating element to move with respect to the locking material. A biasing element, such as a spring, can then cause the moveable actuator element to move in a specific direction, which can cause an end of the actuator element to apply force or pressure to a physical element. This application of force or pressure can actuate a system or trigger a specific action to be performed.

Various embodiments may include a hold down mechanism. A hold down mechanism can comprise a housing having a first end and a second end, as well as an internal cavity. A heating element can be positioned inside the internal cavity. An actuator rod can be positioned to pass between a first opening in the first end of the housing and a second opening in the second end of the housing. The actuator rod can move along an axis passing between the first opening and the second opening when not locked in place. A locking material can be positioned inside the cavity and in contact with at least a portion of the actuator rod. The locking material is able to hold the actuator rod in a hold position when the locking material is in a solid state. The locking material is also able to allow for movement of the actuator rod when the locking material is heated by the heating element to a temperature above a melting point of the locking material. A spring, or other biasing element, can be positioned external to the housing and connected to the actuator rod. The spring is able to apply a biasing force to the actuator rod when the actuator rod is not in a released position with respect to the housing. The actuator rod, when in the hold position, can be caused to move to the released position when the locking material is heated to at least the melting point and allows for movement of the actuator rod.

Various embodiments may include a controllable actuator. A controllable actuator can comprise a housing including a cavity to hold a locking material. An actuator element can be positioned to pass at least partially through the locking material in the cavity of the housing. A biasing element can be used to bias the actuator rod to a default position. When the locking material is in a first state, the locking material is able to hold the actuator element in a hold position. When the locking material in a second state, the locking material allows the actuator element to move to the default position as biased by the biasing mechanism.

Various embodiments also allow for delayed activation of a hold down mechanism. It can be determined that an actuator rod, held in place by a locking material in a lock down mechanism, is to be released to apply force to a physical element. The locking material can then be heated to at least a melting point to allow for movement of the actuator rod with respect to a housing of the lock down mechanism. The biasing element of the hold down device can then cause the actuator rod to be moved in a biased direction toward the physical element.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. It will be readily understood that the aspects of the present disclosure, as generally described herein, and illustrated in the figures, can be arranged, substituted, combined, and designed in a wide variety of different configurations, all of which are explicitly contemplated and make part of this disclosure. As noted above, the drawings as depicted are not necessarily drawn to scale. The relative dimensions and proportions as shown are not intended to limit the present disclosure, unless indicated otherwise. Various embodiments in accordance with the present disclosure will be described with reference to the drawings, in which:

FIG. 1 illustrates a partial cross-sectional view of a hold down mechanism, in accordance with at least one embodiment;

FIGS. 2A and 2B illustrate partial cross-sectional views of hold down and lock mechanism in locked and released states, respectively, in accordance with at least one embodiment;

FIGS. 3A and 3B illustrate perspective views of hold down and lock mechanisms in locked and released states, in accordance with at least one embodiment;

FIG. 4 illustrates a system for providing timed actuation of a physical element, in accordance with at least one embodiment;

FIG. 5 illustrates an example process that can perform timed actuation of a physical element using a hold down mechanism, in accordance with at least one embodiment.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. It should be further appreciated that terms such as approximately or substantially may indicate +/-10 percent.

As used herein, a hold down mechanism may refer to any device or component that can have at least two physical states, with a controllable release between at least one held (or locked) state and at least one released, biased, or default state. A moveable element, such as an actuator rod or spring-loaded pin, can be positioned at least partially passing through a housing of a hold down mechanism. The moveable element can have a force applied by a biasing element, such as a spring, that can bias the spring to be in a release state. The moveable element can be moved to a held or lock position, and a material of the hold down mechanism can apply force or pressure to hold the moveable element in place at the lock position. In one example, the holding can result from a locking material wetting the surface of the moveable element and entering a solid state that locks the moveable element in that position. When the locking material changes state, as may be the result of an increase in temperature to a melting point, the hold on the moveable element can be released and the biasing element can cause the moveable element to translate to the released state. If positioned adjacent a physical element, the translation of the moveable element to the released state can cause force or pressure to be applied to the physical element, which can be used to actuate a physical device or perform another such action.

As used herein, a locking material may refer to any material that is able to change between states, or otherwise have one or more properties modified, where at least one state or property can allow the locking material to hold a moveable element in place. This can occur when, for example, a metal is below a melting point and is in a solid state, which can hold in place an element passing at least partially through the solid metal. When the metal is heated to at least the melting point, the metal will no longer be in a solid state, which can release the hold on the moveable element, allowing the moveable element to move with respect to the locking material. Other states or properties can be used as well, such as may include a compressed or expanded state, where an expanded material may hold a moveable element in place. Example locking materials include metals, alloys, plasmas, gels, and elastic substances that may change state under different temperatures, pressures, magnetic or electric fields, etc.

As used herein, a biasing element can include any element that is capable of applying a biasing force to a moveable element. Such an element can include, for example, a spring, an elastic element, or an element with shape memory that is capable of being expanded or compressed, and while expanded or compressed applies a force or pressure in an attempt to return to an uncompressed or non-extended state. If external forces are available, such as gravity or a magnetic force, an element can be used that is susceptible to that force, such as a magnet or weight, which can cause a force to be applied to a moveable element in at least one specific direction.

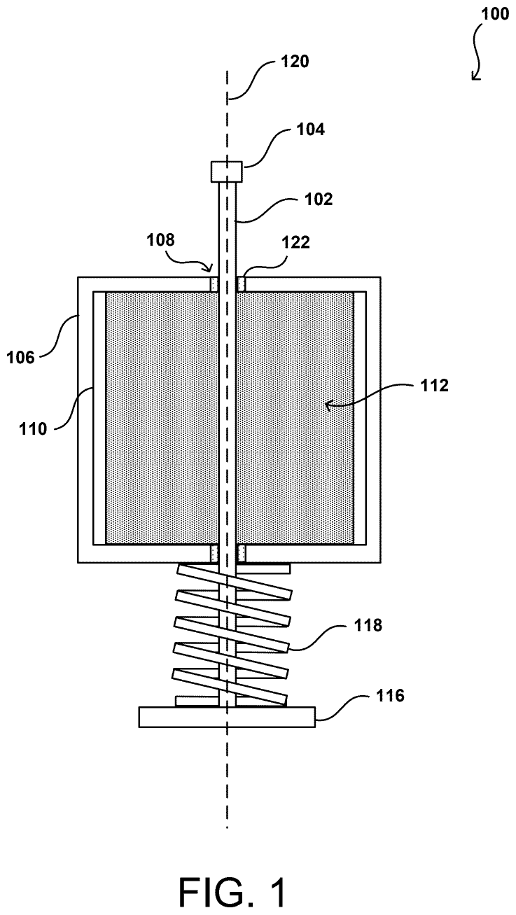

FIG. 1 illustrates a cross-sectional view 100 of a hold down mechanism according to at least one embodiment. In this example, an actuator rod 102 (or pin or other elongated element) is able to be moved along a central axis that is vertical in the figure. The actuator rod 102 is inserted through two openings 108 on opposing sides of a housing 106. In this example, the housing is cylindrical in nature, and the openings 108 are located centrally in planar end faces of the housing. A seal 122 (e.g., a bushing seal) may be positioned in (or proximate) each opening 108 to allow the rod to move back and forth in the openings, along a primary axis of translation 120. Such a seal can help to restrict lateral motion in other directions, and can prevent material from passing into, or out of, the housing 106. The rod can have one or more end portions 104, 116 which can restrict the rod from being pulled, or pushed, out of the housing 106. At least one end portion 116 may be shaped to provide appropriate contact to an actuator mechanism or other physical element to be contacted when the rod is in a released position in this example. As illustrated, a force-applying (or biasing) element such as a spring 118 can be applied in order to apply a force to the rod along the primary axis of translation 120. The force applied by the spring 118, positioned between the housing 106 and an end portion 116 of the rod, can cause the actuator rod 102 to move in a given direction along the primary axis of translation 120, which can be up (in the figure) if the spring is expanded and is able to compress, or down (in the figure) if the spring is compressed and is able to expand. As mentioned, it should be understood that directions such as “up,” “down,” and “vertical” are used for purposes of explanation, and should not be interpreted as requirements or orientation of any of the relevant components or forces unless otherwise specifically stated.

Such a mechanism can generally be used when there are at least two positions of the rod that are to be leveraged to perform a specific task or operation. This can include, for example, the rod positioned as far along the primary axis of translation 120 as possible in a first direction (e.g., up in the figure), and as far along as possible in the opposite direction (e.g., down in the figure). A spring 118 (or other such mechanism) can be used to bias the actuator rod 102 to be in one of these positions when the spring is neither expanded nor compressed. If the actuator rod 102 is translated to be in the second position, the spring 118 can be expanded or compressed, and will be biased to return to its neutral position and move the rod back to the original position. In order to hold the actuator rod 102 in the second position, a locking mechanism (or other such approach) can be used to prevent the force applied by the spring from changing the position of the rod.

In this example, the locking mechanism includes use of a “locking” material that is solid below a certain temperature and not solid (e.g., liquid, viscous, or gas) above that temperature. Such a locking material 112 can be placed within a central cavity of the housing 106. The material can be selected such that the melting point, or the temperature at which the material will no longer be in a solid state but instead in a liquid or viscous state, is higher than the temperature range that would typically be experienced in a given location or set of conditions. One class of materials that can be used for such purposes includes low melting point metals and alloys (e.g., metals that melt below under about 1000° C., or under about 500° C.). In one example, a craft landing on Venus might want to select a locking material that melts at 500° C. or higher, since the temperature on the surface of Venus might rise to around 465° C. If the craft is instead landing on the moon, where the temperature can get as high as around 150° C. when facing the sun, it may be desirable to select a material (e.g., Bismuth, Thallium, or Lead) where the material melts at a temperature of around 200° C. or above. In this example, a metal such as lithium might be used that melts at around 180° C., but for locations where the possible temperature range might exceed that value, a metal such as lead can be used that melts at a higher temperature of 327° C. Various other metals or alloys can be used as well, as may be appropriate for different environments.

In order to make the locking material 112 able to allow for insertion of the actuator rod 102, an internal heater 110 (e.g., a patch heater) can be used that can raise the temperature of the metal to at least the melting point. In other embodiments, there may be an entry port that allows metal at this higher temperature to be poured into the cavity of the housing 106 with the rod already in place, which helps to prevent leakage of the molten metal from openings in the seals. In other examples, the metal may be inserted into the cavity in a solid state and then heated to allow for insertion of the rod, where a plug or unbroken seal can be used to prevent leakage. In still another example, a solid metal can be placed in the cavity that allows for passage of the rod, then an internal heater 110 (or external heater as discussed elsewhere herein) can heat the metal such that the metal flows around, and whets, the surface of the rod. An internal heater 110 can be used to increase the temperature of the locking material 112 to above the melting point when the rod is to be able to move, and can allow the locking material 112 to cool below the melting point, and return to a solid state, when the actuator rod 102 is to be locked in place. Once the locking material has sufficiently cooled, the solid metal whetted to the outer surface of the rod can prevent motion of the rod, effectively locking the rod in place.

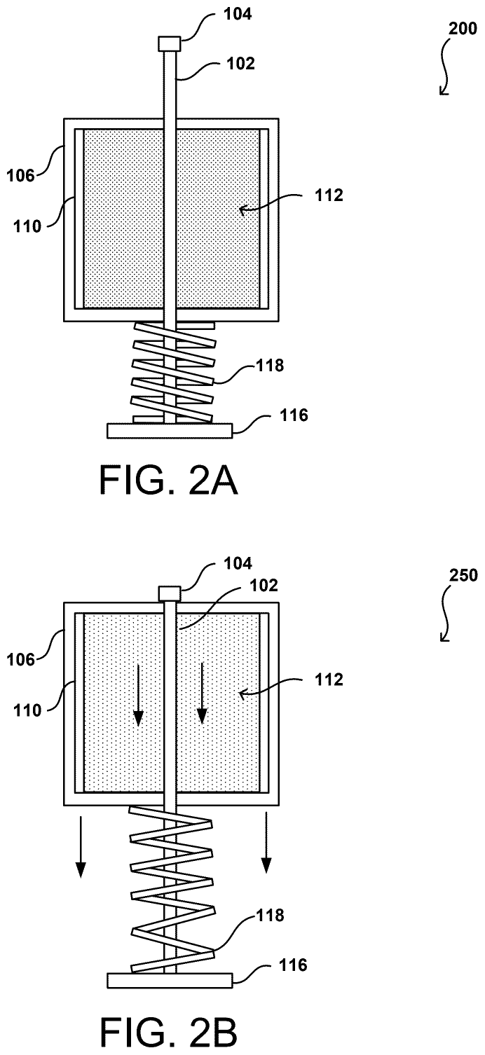

Such an assembly can be used as a type of hold down and release mechanism. FIGS. 2A and 2B illustrate cross-sectional views 200, 250 of the structure of FIG. 1 with the locking material heated to different temperatures. In FIG. 1, the actuator rod 102 would normally be biased by the spring 118 to be as far down in the image as possible, such as where a surface of the top end portion 104 contacts the upper surface of the housing 106 and/or opening 108. In order to “load” the rod into a lock position, the heater 110 can be activated to cause the locking material 112 to melt, such that the actuator rod 102 can be pushed up (in this figure) to a desired position, which can cause the spring to be expanded. In order to lock or secure the rod in position, and prevent the expanded spring from pulling the rod back to its prior position, the heater can be turned off (or at least set to a setting below the melting point of the locking material) to allow the locking material 112 to cool. Once the locking material 112 is at a temperature below the melting point, the locking material will return to a solid state and effectively lock the actuator rod 102 in the current position with respect to the housing.

Referring now to FIG. 2A, it may be desired for the actuator rod 102 to be released, such as to cause the actuator rod 102 to move along the axis of translation and actuate or contact a target component. Reference numbers may be carried over for similar elements between figures for simplicity of explanation and understanding, but such use should not be interpreted as a restriction on the scope of the various embodiments unless otherwise specifically stated. At some time before the release is to occur, the heater can be activated or otherwise adjusted to a setting that will cause the temperature of the locking material 112 to increase. The amount of time at which the heater can be activated ahead of the time for release can depend in part upon the length of time it will take for the locking material 112 to melt. This time can be impacted by various factors, including but not limited to the type of locking material, the type of heater used, or the amount of power and/or setting applied to the heater. As illustrated in the cross-sectional view 200 of FIG. 2A, the actuator rod 102 will remain locked in place while the locking material is being heated but has not yet reached the melting point.

In the cross-sectional view 250 of FIG. 2B, the temperature of the locking material 112 has at least reached the melting point, resulting from application of heat by the internal heater 110. Once the locking material 112 has no portion (or only one or two very small portions) contacting the rod that is still in the solid state, the actuator rod 102 can effectively no longer be locked in place by the locking material 112. Accordingly, the spring 118 which was previously compressed can attempt to return to its uncompressed state. This can result in the bottom of the spring pushing away from the housing 106. This pushing away can apply force to the bottom end portion 116 connected to the actuator rod 102, and thus apply a pulling force that can cause the rod to translate along the primary axis of motion. In the example orientation of FIG. 2B, this will result in the rod moving vertically downward in the figure. If properly oriented, the bottom end portion 116 can then push away from the housing. If the housing is held in place, this results in an extension of the rod below the housing, and a downward motion of the bottom end portion 116. If a button (or other mechanical actuator) is positioned such that the bottom end portion 116 comes into contact, then this release of the actuator rod 102 can result in the bottom end portion 116 applying a force or pressure on the button. This can then result in the pressing of the physical button, or other physical actuation, without the need for human interaction. The speed at which the rod deploys, and the force or pressure applied to the button, can depend upon various factors, such as the strength or shape of the spring, the extension length of the rod, and the evenness of melting of the locking material 112, among other potential factors. The type of spring used can thus depend at least in part upon the strength or amount of pressure needed for the target actuator.

The actuator rod 102 can be of a material that is of sufficient strength to perform the target actuation. The actuator rod 102 can also be of a material that has a melting point higher than that of the locking material, such that the actuator rod 102 will remain in a solid state regardless of the state of the locking material. In one example, the rod is made of a tungsten material. It can be desirable to limit the size of the actuator rod 102 to reduce material, and thus conserve cost and space. By way of example, for a housing that is at least one inch in diameter the actuator rod 102 can have a diameter of at least 5 mm, and for some implementations may have a diameter in the range of about 0.5 cm to about 2.0 cm, among other possible dimensions.

Larger sizes can be used for larger actuators or actuators that require greater strength. The length of the rod can depend in part on the length of the housing 106 and spring 118, as well as the proximity of the mechanism to the actuator when installed. In one example, an actuator rod 102 has a length in the range of about 1 cm to about 30 cm, with a range of motion of about 0.5 cm to about 15 cm. The sizes and/or materials used can depend in part upon the amount of force that needs to be applied, and the spring or other biasing element that is needed to provide that type of force.

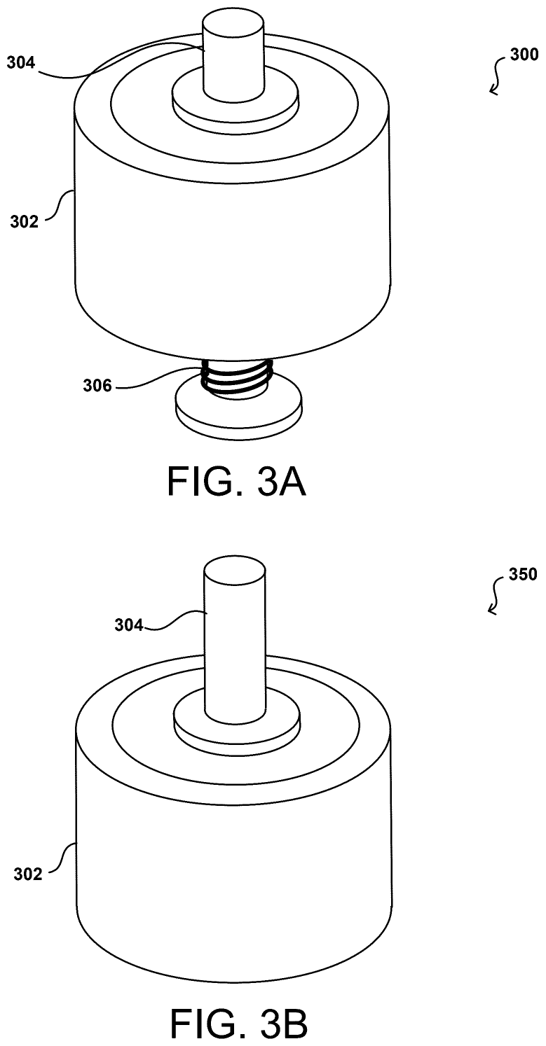

FIGS. 3A and 3B show perspective views 300, 350 of an example hold down mechanism in a locked state and a released state. In this example, the actuator rod 304 is in a locked state in FIG. 3A, with the spring 306 being in an expanded state. As illustrated, only a small portion of the actuator rod 304 extends from the top of the housing 302 when in a locked position. In some embodiments, there may be a range of possible lock positions, as long as the actuator rod 304 is not contacting the target actuator. In this example the housing is cylindrical, although other configurations can be used as well. When an internal heater is used to heat an internal locking material to at least the melting point, and typically some temperature slightly above the melting point to ensure complete melting, the locking material will no longer secure or lock the actuator rod 304 in place. In this example, the spring 306 can then return to its unexpended state, which can cause the released actuator rod 304 to be pushed along the primary axis of motion, in an upward position as illustrated in FIG. 3B. If properly positioned, the extending of the actuator rod 304 can be used to apply pressure or force to a mechanical target as discussed in more detail elsewhere herein.

In the hold down mechanism illustrated in FIGS. 3A and 3B, the hold and lock positions can vary based in part on the type of spring 306 (or other biasing element) used. For example, if the spring 306 in FIG. 3A is in an extended state, then the actuator rod 304 is in a held or locked position, and when released moves to the actuating position in FIG. 3B. Alternatively, if the spring 306 in FIG. 3A is in a rest or non-extended/uncompressed state, then the actuating rod in FIG. 3A can be in the released or actuating position, and can be moved into a locked or held position as in FIG. 3B, which causes the spring to be compressed in FIG. 3B. In at least one embodiment, an actuating mechanism can have three possible states. When at rest and a spring is not extended or compressed, the actuating rod can be in a middle position where an amount of the rod extending above and below the housing 302 may be similar. The rod can be moved into a first lock position by compressing the spring, which may cause more of the rod to extend from a first end of the housing 302, or may be moved into a second lock position by extending the spring, which may cause more of the rod to extend from a second, opposite end of the housing 302. Such usage can allow the hold down mechanism to operate in either direction (or both directions) along the primary axis of motion of the actuating rod.

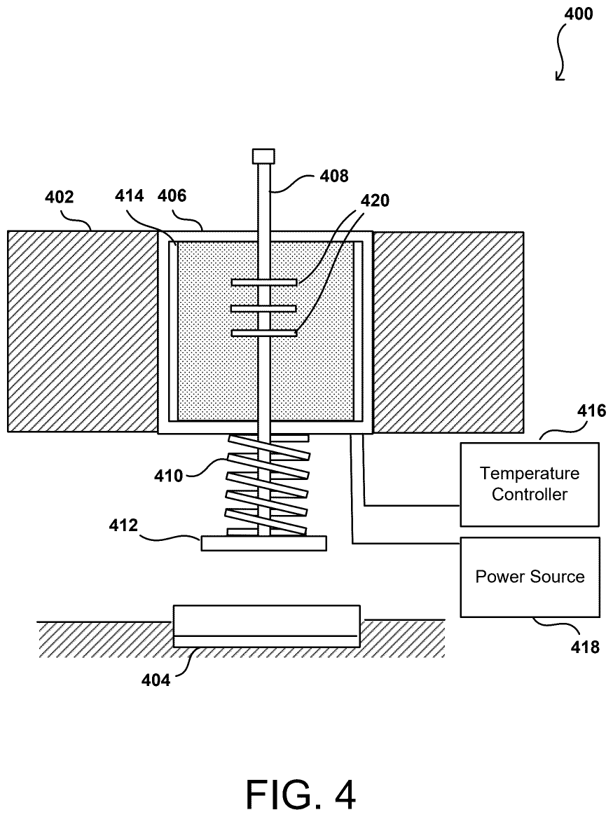

FIG. 4 illustrates a partial cross-sectional view 400 where the housing 406 of an example hold-down mechanism is secured in place using appropriate support structure 402. Any appropriate support structure can be used, such as a clamp, weld, bolt, adhesive, and the like. The housing 406 can be positioned such that an end portion 412 of a releasable rod 408 is near an actuator 404 or other such target, such as a button that is to be pressed at an appropriate time to trigger a corresponding action. In other embodiments, an actuator may take the form of a pin to be pulled, or switch to be contacted, among other such options that may be associated with different types of actions, motions, contacts, and/or actuations, which in one embodiment may indicate that an actuator completed a designed stroke or actuation. In a locked state, the end portion 412 can apply no pressure on the actuator 404, and in fact may be separated at least a given distance (e.g., at least about 1 mm-5 mm) from the actuator. Before a time at which the actuator 404 it to be activated, a heater 414 can be activated, or have a temperature setting increased, to cause the locking material in the housing 406 to increase temperature to at least a melting point. The heater 414 can have one or more wires that extend from the housing in order to receive power from an external power source 418, although in some instances the heater may have an internal battery or other source of power. The heater 414 may also have one or more wires that extend from the housing 406 to enable receipt of a control signal from a temperature controller 416 or other such source (e.g., a control system or computer with temperature control capability). In some examples, the temperature can be controlled by the amount of power applied to the heater, as well as the duration over which the power is supplied. The heater may include, or may work in conjunction with, a thermostat or temperature sensor in the housing 406 that can provide a temperature of at least the locking material.

When the locking material at least reaches the melting point, the locking material can begin to melt. Once sufficiently melted (or otherwise no longer in a solid state), the locking material will no longer hold the releasable rod 408 in place and the spring 410 can decompress to cause the releasable rod 408 to move downward in FIG. 4 along the primary axis of motion. The end portion 412 can then contact, and apply pressure to, the actuator 404, which can trigger the corresponding action. In situations where it may be desirable to slow the speed of the releasable rod 408 upon release, there may be washers 420 or other elements or extensions connected to the rod that may slow the motion. In this example, washers 420 are positioned in the locking material, and those washers will resist the motion of the rod which can cause the rod to move more slowly when released. The rod itself may be textured, patterned, or shaped as well. As an example, texturing can help the rod to be held in place when the locking material is solid, and can also potentially slow release of the rod as the locking material melts.

Although an example heating element has been discussed that wraps around an inner circumference of a cavity within the mechanism housing, it should be understood that other configurations can be used as well. For example, a heating element can be positioned around a portion of the circumference, or at a top or bottom of the cavity. There may alternatively (or additionally) be heating element(s) that extend into the cavity and have the melted material poured around them. The heating element(s) should be able to support the desired melting temperature without compromise. In other embodiments, a heating element may be used to increase the temperature of at least a portion of the actuating rod, which can then melt the locking material proximate the rod and locking the actuating rod in place. Such a heating element can apply heat within, or external to, the housing. Other heating approaches can be used as well, as may involve the use of microwaves directed from outside the housing, and the like. The actuating rod and seals can be made of materials, such as ceramics, that can also withstand these increased temperatures without compromise. In one example, an actuating rod is formed of tungsten with a high melting point of around 2000° C. An actuating rod can also be selected to be of a material that is whetting capable with respect to the selected locking material, in order to provide for sufficient locking or gripping power when the locking material is below the melting temperature. The coefficient of thermal expansion (CTE) of the rod material can also be considered, as the CTE of a rod and seal may need to be comparable to allow for motion of the rod within an opening of the seal over a large temperature range, while still preventing a flow of material through gaps between the seal and rod.

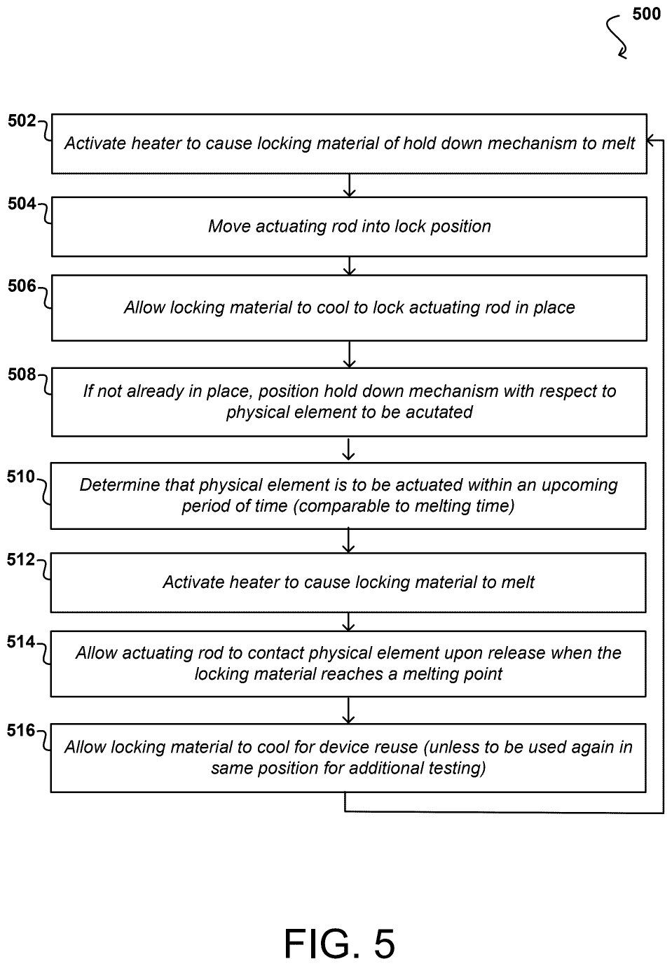

FIG. 5 illustrates an example process 500 that can be used to operate a hold and release mechanism in accordance with at least one embodiment. It should be understood that for this and other processes presented herein that there may be additional, fewer, or alternative operations performed in similar or alternative orders, or at least partially in parallel, within the scope of the various embodiments unless otherwise specifically stated. In this example, a temperature-based hold and lock mechanism is to be used to actuate a physical element as discussed herein. It should be understood that such mechanisms can be used for other purposes as well, such as where a timed physical contact or application of force and/or pressure is to be provided. In this example, a heater element can be activated 502 by applying power, increasing applied power, or supplying a control signal, among other such options. The heater element can be caused to raise the temperature of a locking material of the hold and lock mechanism to a melting point, or other temperature at which the locking material changes phase or state. Before the temperature is increased, an actuating rod of the hold and lock mechanism is locked in place. Once the temperature of the locking material is increased and the locking material reaches a melting point and is no longer in a solid state, for example, the actuating rod can be moved back and forth with respect to a housing of the hold and lock mechanism. This motion may be biased to a specific position by a spring or other biasing element. The actuating rod can be moved 504 into a “lock” position, or other position (over a range of possible positions) where the rod is to be held in place until such time as an actuation (or motion of the rod in a given direction and distance) is to occur. Once the actuating rod is in place, the locking material can be allowed 506 to cool, or return to a temperature below the melting point of the locking material, so that the actuating rod will be locked or secured in place at the lock position. The hold down mechanism can then be considered to be in a “hold” or ready state.

In this state, the hold down mechanism can be used to actuate a physical element, or perform another action related to a release of the actuating rod. If the hold down mechanism is not already in the appropriate location and orientation, then the hold down mechanism can be positioned 508 with respect to the physical element to be actuated (or otherwise to have force) or pressure applied in a given direction (or range of directions) by an end of the actuating rod. In situations where the hold down mechanism is to be reused for the same task, the mechanism may already be in the appropriate location. It can be determined 510 that the physical element is to be actuated within an upcoming period of time. This period of time can correspond to a range of times it is expected to take for the locking material to reach the melting point and the actuating rod be released. The heater of the hold down mechanism can be activated 512 (or a setting adjusted) to cause the locking material to increase in temperature until the locking material melts. The actuating rod can then be allowed 514 to contact the physical element upon release when the locking material sufficiently melts. The element can trigger an action to be performed in a physical system or device, such as a robotic assembly that raises an antenna, activates a drill, or provides for a period of shock absorption during craft landing, as example uses. The spring or other biasing element can apply force to the actuating rod such that the rod moves in a corresponding direction as soon as it is no longer locked or held in place by the locking material. After actuation has occurred, the locking material can be allowed 516 to cool and the hold down mechanism can be made available for reuse. If the hold down mechanism is to be reused in a short period of time and in the same location and orientation, for example, the locking material may be maintained at the higher temperature so that the actuating rod can be reset before the locking material cools and the actuating rod is locked in place. The ability to reset and reuse these devices provides savings and reduces installation time versus prior mechanisms that used explosives or similar techniques to achieve release, which are only able to be used one time for a single release, and then must be removed and replaced with a new mechanism. Existing actuators that do allow for reset often require expensive tools and a lot of time to reset, which often also requires removing the mechanism from its location of use in order to perform the reset. Heating-dependent hold down devices can take some time to reach temperature, however, so may not be optimal for use cases where instantaneous release is desired.

Although solid materials that melt at certain temperatures are discussed as primary locking material examples, there are various other materials, components, or mechanisms that can be used for holding and releasing operations within the scope of various embodiments. For example, there may be materials that change state or phase from solid to a state such as a gas, plasma, or gel, which may allow for release of an actuating rod. Similarly, there may be a material that might be in a gel or plasma phase that might apply pressure to an actuating rod that can hold the rod in place, or may be able to apply pressure to release a rod. Any material that can change phase or state, where one phase can be used to hold an actuating rod or element and the other can be used to allow for release or movement of such a rod or element, can be used within the scope of various embodiments. Some materials do not change state other than to expand or contract, which can be used to lock and release an actuating rod as well.

Other variations are within spirit of present description. Thus, while the described techniques are susceptible to various modifications and alternative constructions, certain illustrated embodiments thereof are shown in drawings and have been described above in detail. It should be understood, however, that there is no intention to limit description to specific form or forms described, but on contrary, intention is to cover all modifications, alternative constructions, and equivalents falling within spirit and scope of description, as defined in appended claims.

Terms such as “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Use of any and all examples, or exemplary language (e.g., “such as”) provided herein, is intended merely to better illuminate embodiments of the description and does not pose a limitation on scope of description unless otherwise claimed. No language in specification should be construed as indicating any non-claimed element as essential to practice of the description.

Although descriptions herein set forth example implementations of described techniques, other architectures may be used to implement described functionality, and are intended to be within scope of this description. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are described as exemplary forms of implementing the claims.

What is claimed is:

1. A hold down mechanism, comprising:
a housing having a first end and a second end, and an internal cavity;
a heating element positioned inside the internal cavity;
an actuator rod passing between a first opening in the first end of the housing and a second opening in the second end of the housing, and able to move along an axis passing between the first opening and the second opening;
a locking material inside the cavity and in contact with at least a portion of the actuator rod, wherein the locking material is able to hold the actuator rod in a hold position when the locking material is in a solid state, and wherein the locking material is able to allow for movement of the actuator rod when the locking material is heated by the heating element to a temperature above a melting point of the locking material; and
a spring positioned external to the housing and connected to the actuator rod, the spring able to apply a bias force to the actuator rod when the actuator rod is not in a released position with respect to the housing, wherein the actuator rod when in the hold position is caused to move to the released position when the locking material is heated to at least the melting point and allows for movement of the actuator rod.

2. The hold down mechanism of claim 1, further comprising:
a first seal encircling the actuator rod proximate the first opening; and
a second seal encircling the actuator rod proximate the second opening, the first seal and the second seal allowing for movement of the actuator rod within a central opening while preventing the locking material, when not in a solid state, from leaking out of the central opening.

3. The hold down mechanism of claim 1, wherein the actuator rod, the first seal, and the second seal have respective melting temperatures above the melting temperature of the locking material, and wherein the actuator rod, the first seal, and the second seal are formed of one or more materials have similar coefficients of thermal expansion.

4. The hold down mechanism of claim 1, further comprising:
selecting the locking material based in part upon an expected temperature range of an environment in which the hold down mechanism is to be used, wherein the melting point of the locking material is greater than the expected temperature range.

5. The hold down mechanism of claim 1, wherein the actuator rod has at least one of a surface texture, a shape, or a surface roughness that facilitates an ability of the locking material to hold the actuator rod in the hold position when the locking material is in the solid state.

6. The hold down mechanism of claim 1, wherein the actuator rod includes one or more extensions positioned within the locking material to reduce a speed at which the actuator rod is able to move through the locking material when not in the solid state.

7. The hold down mechanism of claim 1, wherein the spring is able to be biased in at least a compressed direction or an expanded direction to apply the bias force to the actuator rod in either a first direction or a second direction.

8. The hold down mechanism of claim 1, wherein the hold down mechanism is able to be positioned such that the actuator rod, when moved into the released position, applies a force or pressure to an physical element to trigger performance of a target action of a physical system.

9. The hold down mechanism of claim 1, wherein the locking material is a metal or an alloy having a melting temperature below 500° C.

10. A controllable actuator, comprising:
a housing including a cavity to hold a locking material;
an actuator element passing at least partially through the locking material in the cavity of the housing; and
a biasing element for biasing the actuator rod to a default position,
wherein the locking material in a first state is able to hold the actuator element in a hold position, and wherein the locking material in a second state allows the actuator element to move to the default position as biased by the biasing mechanism.

11. The controllable actuator of claim 10, wherein the locking material is a metal or an alloy, wherein the first state is a solid state when the locking material is below a melting point, and wherein a heater is able to be used to heat the locking material to at least a melting point to be in the second state.

12. The controllable actuator of claim 10, wherein the biasing element is a spring in contact with the actuator rod and the housing, and wherein the biasing is accomplished through at least an extension or a compression of the spring.

13. The controllable actuator of claim 10, further comprising:
a first seal encircling the actuator element proximate a first opening in the housing; and
a second seal encircling the actuator element proximate a second opening in the housing, the first seal and the second seal allowing for movement of the actuator element within a central opening while preventing the locking material, when not in a solid state, from leaking out of the central opening.

14. The controllable actuator of claim 10, wherein the actuator element is a textured rod having a melting point above the melting point of the locking material.

15. The controllable actuator of claim 10, wherein the actuator element includes one or more extensions positioned within the locking material to reduce a speed at which the actuator element is able to move through the locking material when not in the solid state.

16. The controllable actuator of claim 10, further comprising:
a heating element positioned within the cavity to control a temperature of the locking material.

17. A method, comprising:
determining that an actuator rod, held in place by a locking material in a lock down mechanism, is to be released to apply force to a physical element; and
heating the locking material to at least a melting point to allow for movement of the actuator rod with respect to a housing of the lock down mechanism, wherein a biasing element of the hold down device causes the actuator rod to be moved in a biased direction toward the physical element.

18. The method of claim 17, further comprising:
heating the locking material to allow for movement of the actuator rod to allow the actuator rod to be moved to a hold position that is biased by the biasing element; and
allowing the locking material to cool to below the melting point in order to hold the actuator rod in place before causing the actuator rod to be moved in the biased direction toward the physical element.

19. The method of claim 17, further comprising:
after causing the actuator rod to be moved in a biased direction toward the physical element, heating the locking material to at least a melting point and returning the actuator rod to the hold position to allow for reuse of the lock down mechanism.

20. The method of claim 17, further comprising:
selecting the locking material to have a melting point above an expected temperature range of an environment in which the lock down mechanism is to be deployed.
